(19) United States
(12) Patent Application Publication
(10) Pub. No.: US 2018/0175654 A1
(43) Pub. Date: Jun. 21, 2018

(54) Portable Speaker Charging Structure

(71) Applicant: Sound Cheers Limited, Tortola (VG)

(72) Inventors: Joo Suah Ang, Singapore (SG); Kheng Wee Lee, Singapore (SG); Yeh Huar Kek, Singapore (SG)

(21) Appl. No.: 15/387,626

(22) Filed: Dec. 21, 2016

(51) Int. Cl. H02J 7/02; H02J 7/00; H04R 1/02

(52) U.S. Cl. CPC H02J 7/025; H02J 7/0044; H04R 2420/09; H04R 2420/07; H04R 1/026

(57) ABSTRACT

A portable speaker charging structure comprises an outer case body and a speaker device, wherein the outer case body includes an accommodation space having a charging device and at least a separable inner case, and wherein the separable inner case is placed over the charging device and the speaker device is placed on the separable inner case. The charging device allows to electrically charge the speaker device such that a user needs only to carry the outer case body when travelling outdoors without having to take the speaker and the charging device thereby significantly saving space occupied by the goods the user carrying along. In addition, the portable speaker charging structure according to the present invention can be further applied as a mobile power source.

### BACKGROUND OF THE INVENTION

### 1. Field of the Invention

The present invention generally relates to a portable speaker charging structure; in particular, it relates to a hand-carried speaker enabling the electric charging function. In addition, the portable speaker charging structure according to the present invention can be further applied as a mobile power source.

### 2. Description of Related Art

At present, the Bluetooth speaker is a type of electronic products that people highly heed to because, essentially, it allows users to play music files stored in the smartphone anytime and anywhere, can be carried along conveniently and enables wireless connections, thus resulting in great popularity among people all over the world. However, since it is portable, in case the user is travelling outdoors for a long duration of time, the Bluetooth speaker may run out of electricity and become inoperable.

Meanwhile, suppose the user intends to charge the speaker while he is outdoors, currently it is required to additionally carry a mobile power source as well as charging cables for this purpose, thus leading to a more scattered and messy condition for the goods carried along when he/she is travelling and greater inconvenience accordingly; besides, seeing that one mobile power source may be applied to charge a plurality of various electronic products so that the Bluetooth speaker generally may not be placed together with the mobile power source, which may cause the user to possibly forget to bring the mobile power source or the charging cable along with him/her upon going out, so this could also become a problem. Therefore, the present invention can be an optimal solution if it is possible to offer a design featuring the combination of the mobile power source and the Bluetooth speaker or else other chargeable speaker in a product-set approach thereby resolving the issue of electric power shortage and inoperability in the chargeable speaker when running out of electricity, and further allowing the speaker device to be applied as a mobile power source for use.

### SUMMARY OF THE INVENTION

A portable speaker charging structure comprises: an outer case body, including an accommodation space, in which the outer case body has an upper lid; a charging device, placed within the accommodation space of the outer case body; a separable inner case, placed within the accommodation space of the outer case body, in which the separable inner case is placed over the charging device and comprises a placement space and an opening; and at least a speaker device, placed on the placement space of the separable inner case, in which the speaker device is further connected to at least a charging line which can penetrate through the opening of the separable inner case and electrically connect to the charging device within the accommodation space of the outer case body so as to charge the speaker device by means of the charging device.

In a preferred embodiment, at least one power source terminal connected to the inside of the accommodation space is installed on the external surface of the outer case body, and one end of the power source terminal is electrically connected to the charging device while the other end of the power source terminal is used to electrically connect an electric power line to an external power source end thereby charging the charging device.

In a preferred embodiment, at least one power supply terminal connected to the inside of the accommodation space is installed on the external surface of the outer case body, and one end of the power supply terminal is electrically connected to the charging device while the other end of the power supply terminal can further electrically connect a power source connection line to an external device thereby charging the external device with the charging device.

In a preferred embodiment, the power supply terminal can be a USB port.

In a preferred embodiment, the speaker device can be a Bluetooth speaker.

In a preferred embodiment, the speaker device can be fixed onto the separable inner case or separately utilized on the separable inner case.

A portable speaker charging structure comprises: an outer case body, including an accommodation space, in which the outer case body has an upper lid; a charging device, having a wireless charging module and placed within the accommodation space of the outer case body; a wireless charging base, including a placement space, in which the wireless charging base is placed within the accommodation space of the outer case body and located on the charging device; and at least one speaker device, including a wireless charging module, in which the speaker device is placed on the placement space of the wireless charging base such that the charging device can wirelessly charge the wireless charging module of the speaker device by means of the wireless charging module thereof.

In a preferred embodiment, the wireless charging module of the charging device can be installed on the wireless charging base such that the wireless charging module can be electrically connected to the charging device thereby enabling the power source output of the charging device.

### BRIEF DESCRIPTION OF THE DRAWINGS

FIG. 1A shows a Product exploded view of the portable speaker charging structure according to the present invention.

FIG. 1B shows a Product fully assembled view of the portable speaker charging structure according to the present invention.

FIG. 1C shows a Product fully assembled view, at another angle, of the portable speaker charging structure according to the present invention.

FIG. 2 shows an embodiment view of the portable speaker charging structure according to the present invention.

FIG. 3 shows an embodiment view of the portable speaker charging structure according to the present invention.

FIG. 4A shows a second embodiment view of the portable speaker charging structure according to the present invention.

FIG. 4B shows the application status view for the second embodiment of the portable speaker charging structure according to the present invention.

### DETAILED DESCRIPTION OF THE PREFERRED EMBODIMENTS

Other technical contents, aspects and effects concerning the present invention can be clearly appreciated through the detailed descriptions on the preferred embodiments of the present invention in conjunction with the appended drawings.

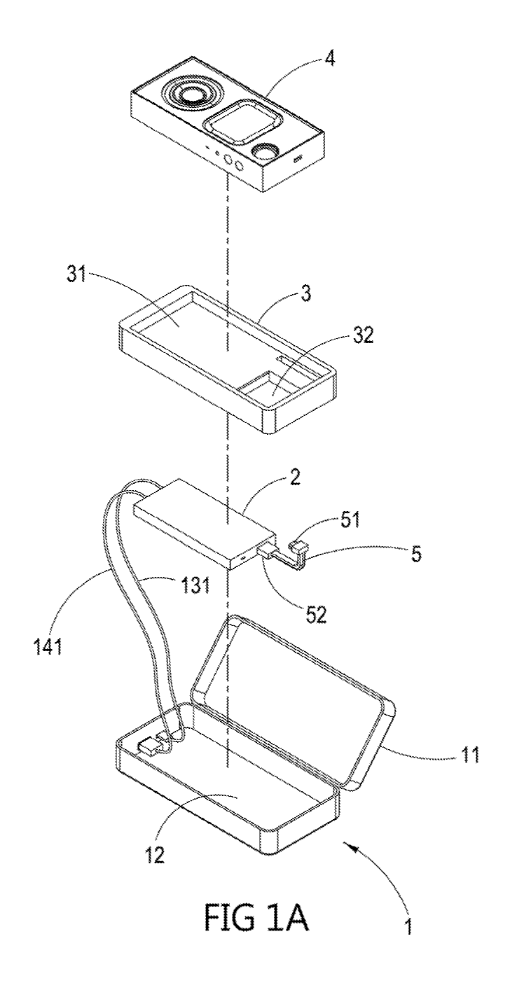

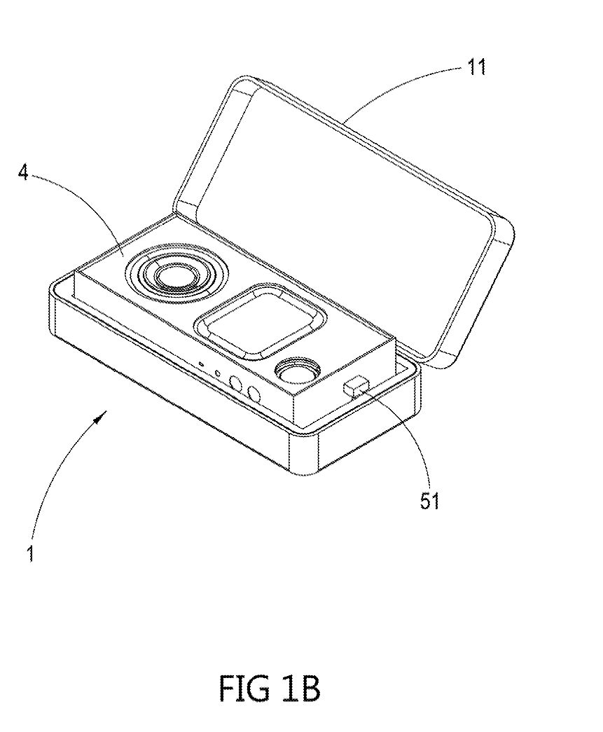

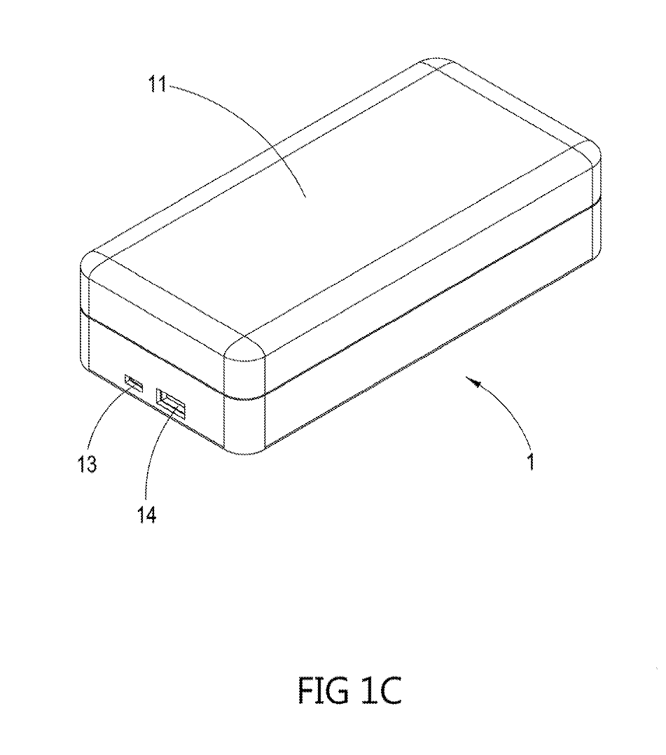

Refer first to FIGS. 1A-1C, wherein a product exploded view, a product fully assembled view and a product fully assembled view at another angle, of the portable speaker charging structure according to the present invention are respectively shown. Herein the portable speaker charging structure comprises an outer case body 1 which includes an upper lid 11 and an accommodation space 12, and at least one power source terminal 13 and power supply terminal 14 connected to the inside of the accommodation space 12 are installed on the outer surface of the outer case body 1, in which the power supply terminal 14 can be a USB port.

Also, the accommodation space 12 can be configured with at least one charging device 2 and at least one separable inner case 3, wherein the separable inner case 3 may be placed over the charging device 2 and, on the separable inner case 3, there can be installed with a placement space and an opening 32, while at least one speaker device 4 can be placed on the placement space 31 of the separable inner case 3. Moreover, the speaker device 4 can be further connected to at least one charging line 5 which has a Micro USB end 51 and a USB end 52, wherein the Micro USB end 51 can be connected onto the speaker device, while the other end of the charging line 5 can penetrate through the opening 32 of the separable inner case 3 such that the USB end 52 can be electrically connected to the charging device 2 thereby charging the speaker device 4 with the charging device 2.

Herein the speaker device 4 may be a Bluetooth speaker or other type of chargeable speaker, and possibly fixed onto the separable inner case 3 or else utilized separately on the separable inner case 3.

Furthermore, the power source terminal 13 can be electrically connected to the charging device 2 via a connection line 131, wherein the power source terminal 13 can be applied to connect a power source line 6 to an external power source end 7 so as to charge the charging device 2; and, besides, the power supply terminal 14 is electrically connected to the charging device 2 through a connection line 141, wherein the power supply terminal 14 can be employed to electrically connect a power source connection 8 to an external device 9 thereby charging the external device 9 with the charging device 2.

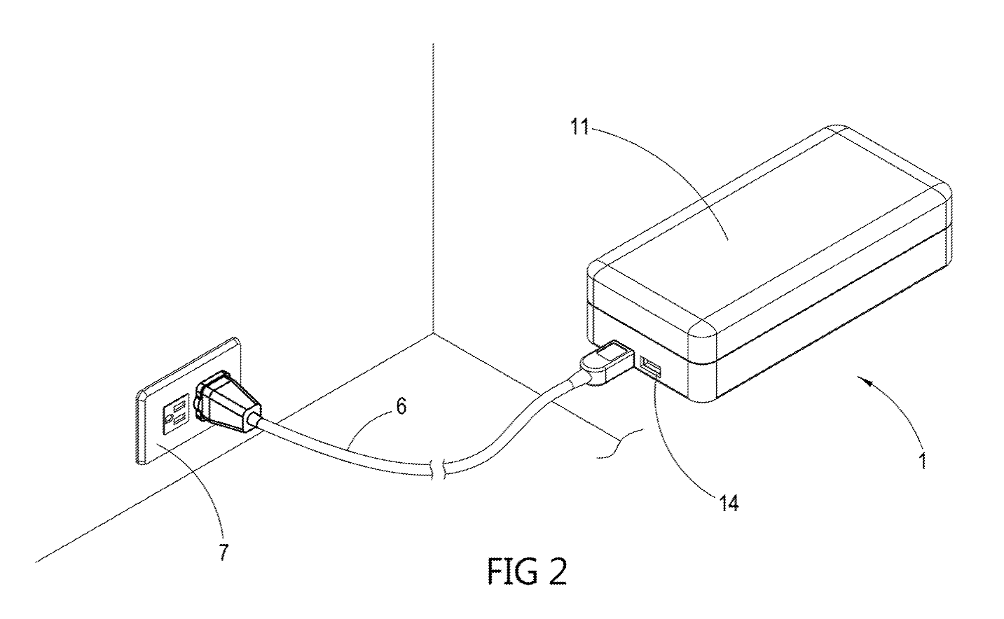

In case the charging device 2 is running out of its internal electricity, as shown in FIG. 2, it is necessary to connect the power source line 6 at the power source terminal 13, and the front end of the power source line 6 has a plug thus allowing to electrically connect to an external power source end 7 for replenishing the internal electricity of the charging device 2.

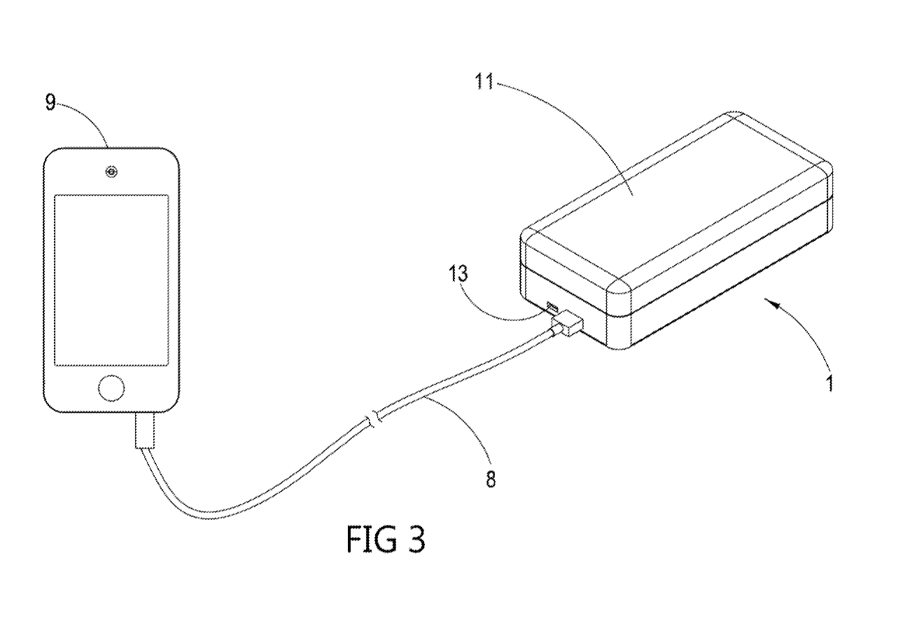

In addition, the portable speaker charging structure according to the present invention also enables the function of mobile power source, so that, upon using the portable speaker charging structure to charge other devices, as shown in FIG. 3, it needs to electrically connect the power source connection line 8 to the external device 9 at the power supply terminal 14 so as to charge the external device 9 by means of the charging device 2.

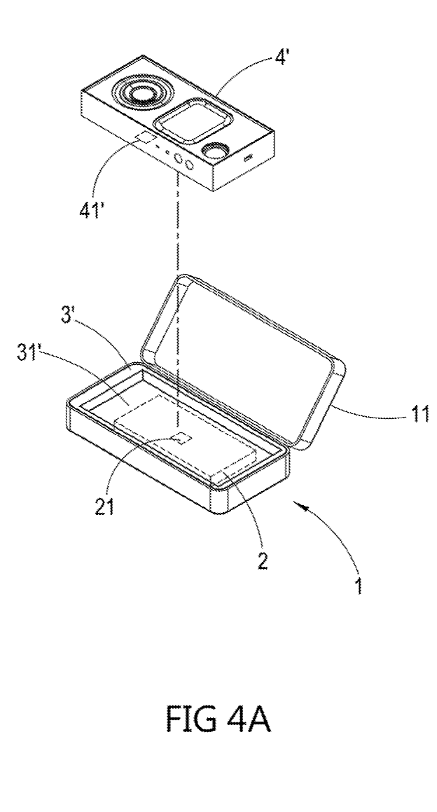

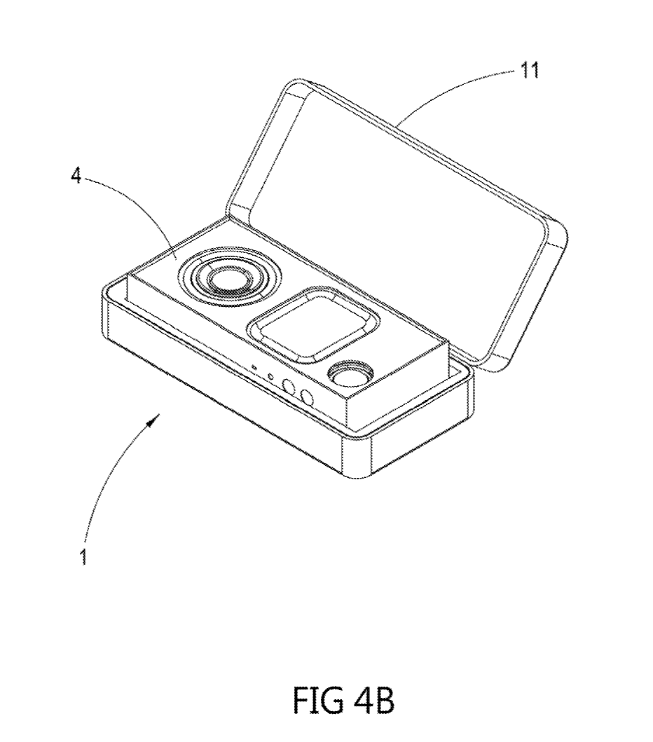

Next, refer to FIGS. 4A-4B, wherein a view and an application status view for a second embodiment of the present invention are respectively shown. Herein the separable inner case 3 shown in FIG. 1A may be replaced with a wireless charging base 3′ which similarly has a placement space 31′, and the wireless charging base 3′ as well as the charging device 2 are both set up within the accommodation space of the outer case body 1 while the wireless charging base 3′ is located over the charging device 2; the charging device 2 further includes a wireless charging module 21 such that, upon placing a speaker device 4′ having a wireless charging module on the placement space 31′ of the wireless charging base 3′, the charging device 2 can charge the wireless charging module 41′ of the speaker device 4′ in a wireless approach by means of the wireless charging module 21 thus allowing to remove installations of typically required charging lines and plugs. Additionally, it is also possible to charge the wireless charging module 21 of the outer case body 1 via an external wireless charging device (not shown) in order to provide electric power to the charging device 2 by means of the wireless charging module 21 thus achieving the objective of power storage in the charging device 2.

Moreover, the wireless charging module 21 of the charging device 2 can be installed on the wireless charging base 3′ as well, such that the wireless charging module 21 can be electrically connected to the charging device 2 thereby enabling the power source output of the charging device 2.

Compared with other conventional technologies, the portable speaker charging structure according to the present invention provides the following advantages:

The present invention offers a combination of the mobile power source and the speaker device or other chargeable speaker into a product set such that the user needs not to worry about bringing the mobile power source along with him/her upon carrying the speaker device outdoors, thus facilitating the convenient hand-carry feature and also resolving possible inoperability of the Bluetooth speaker due to lack of electricity therein.

In addition to acting as the power source for the speaker, the present invention can be further applied as a mobile power source such that other electronic products may also have sufficient electric power for connecting to the speaker device thus enabling the function of multi-usage in a single product.

The present invention can be implemented to operate in a wireless charging mode, which requires only the installation of a wireless charging module on the charging device thus sufficing to wirelessly charge the speaker of the wireless charging module; hence, it is possible to greatly save the utilization of various charging lines and plugs thus achieving the objective of efficient use of space.

It should be noticed that, although the present invention has been disclosed through the detailed descriptions of the aforementioned embodiments, such illustrations are by no means used to restrict the scope of the present invention; that is, skilled ones in relevant fields of the present invention can certainly devise any applicable alternations and modifications after having comprehended the aforementioned technical characteristics and embodiments of the present invention without departing from the spirit and scope thereof. Hence, the scope of the present invention to be protected under patent laws should be delineated in accordance with the claims set forth hereunder in the present specification.

What is claimed is:

1. A portable speaker charging structure, comprising:
an outer case body, including an accommodation space, in which the outer case body has an upper lid;
a charging device, placed within the accommodation space of the outer case body;
a separable inner case, placed within the accommodation space of the outer case body, in which the separable inner case is placed over the charging device and comprises a placement space and an opening;
at least a speaker device, placed on the placement space of the separable inner case, in which the speaker device is further connected to at least a charging line which can penetrate through the opening of the separable inner case and electrically connect to the charging device within the accommodation space of the outer case body so as to charge the speaker device by means of the charging device.

2. The portable speaker charging structure according to claim 1, wherein at least one power source terminal connected to the inside of the accommodation space is installed on the external surface of the outer case body, and one end of the power source terminal is electrically connected to the charging device while the other end of the power source terminal is used to electrically connect an electric power line to an external power source end thereby charging the charging device.

3. The portable speaker charging structure according to claim 1, wherein at least one power supply terminal connected to the inside of the accommodation space is installed on the external surface of the outer case body, and one end of the power supply terminal is electrically connected to the charging device while the other end of the power supply terminal can further electrically connect a power source connection line to an external device thereby charging the external device with the charging device.

4. The portable speaker charging structure according to claim 3, wherein the power supply terminal can be a USB port.

5. The portable speaker charging structure according to claim 1, wherein the speaker device can be a Bluetooth speaker.

6. The portable speaker charging structure according to claim 1, wherein the speaker device can be fixed onto the separable inner case or separately utilized on the separable inner case.

7. A portable speaker charging structure, comprising:
an outer case body, including an accommodation space, in which the outer case body has an upper lid;
a charging device, having a wireless charging module and placed within the accommodation space of the outer case body;
a wireless charging base, including a placement space, in which the wireless charging base is placed within the accommodation space of the outer case body and located on the charging device;
at least one speaker device, including a wireless charging module, in which the speaker device is placed on the placement space of the wireless charging base such that the charging device can wirelessly charge the wireless charging module of the speaker device by means of the wireless charging module thereof.

8. The portable speaker charging structure according to claim 7, wherein the wireless charging module of the charging device can be installed on the wireless charging base such that the wireless charging module can be electrically connected to the charging device thereby enabling the power source output of the charging device.

9. The portable speaker charging structure according to claim 8, wherein the speaker device can be a Bluetooth speaker.
